(19) United States
(12) Patent Application Publication
(10) Pub. No.: US 2026/0109897 A1
(43) Pub. Date: Apr. 23, 2026

(54) GREEN QUANTUM DOTS WITH A GRADIENT LAYER AND MANUFACTURING METHOD THEREOF

(71) Applicant: UIF (University Industry Foundation), Yonsei University, Seoul (KR)

(72) Inventors: Kangtaek LEE, Seoul (KR); Ho Seok HEO, Seoul (KR); Seungho BAEK, Seoul (KR); Seungmin HAN, Seoul (KR)

(73) Assignee: UIF (University Industry Foundation), Yonsei University, Seoul (KR)

(21) Appl. No.: 19/343,905

(22) Filed: Sep. 29, 2025

(30) Foreign Application Priority Data
Oct. 21, 2024 (KR) 10-2024-0143553
Sep. 9, 2025 (KR) 10-2025-0128318

(51) Int. Cl. C09K 11/88; B82Y 20/00; B82Y 40/00

(52) U.S. Cl. CPC C09K 11/883; B82Y 20/00; B82Y 40/00

(57) ABSTRACT

The present invention relates to green quantum dots with a gradient layer and a manufacturing method thereof. The quantum dots of the present invention can exhibit excellent quantum dot performance by introducing a gradient layer between the ZnSeTe core and the multi-shell, thereby alleviating lattice mismatch and reducing interfacial defects.

### CROSS-REFERENCE TO RELATED APPLICATION

This application claims priorities to Korean Patent Applications Nos. 10-2024-0143553 and 10-2025-0128318, filed on Oct. 21, 2024 and Sep. 9, 2025, respectively, and all the benefits accruing therefrom under 35 U.S.C. § 119, the contents of which in its entirety are herein incorporated by reference.

### BACKGROUND

### 1. Field

The present invention relates to green quantum dots with a gradient layer and a manufacturing method thereof.

### 2. Description of the Related Art

Quantum dots (QDs) are well known as semiconductor nanocrystals with unique optical and electronic properties due to the quantum confinement effect. These properties include tunable emission wavelength, high photoluminescence quantum yield (PLQY), and excellent color purity and stability, making QDs highly attractive materials for display and lighting applications, but conventional Cd or Pb-based QDs pose serious environmental and health risks due to their toxic heavy metal content. Therefore, there is an urgent need to develop non-toxic alternative materials that provide high performance and environmental safety.

To date, InP QDs have been extensively researched as an alternative to Cd or Pb-based QDs. InP QDs, as red QDs, exhibit excellent optical properties such as 100% PLQY and a full width at half-maximum (FWHM) of 35 nm, but smaller green and blue InP cores are unstable, primarily due to lattice mismatch with shells such as GaP or ZnS, leading to interfacial defects.

To overcome these problems, ZnSeTe QDs have been studied as blue QDs, and the emission wavelength can be controlled by adjusting the Te/Se ratio. In addition, ZnSeTe QDs provide better light absorption characteristics essential for display applications than InP QDs.

One of the major challenges in ZnSeTe QD synthesis is minimizing the width of the emission peak. For blue ZnSeTe QDs, it has been proposed that Te aggregation and Te-induced localized hole states cause tailing and broadening of the emission peak in the photoluminescence (PL) spectrum. Recently, blue ZnSeTe QDs with a PLQY close to 1 and a narrow FWHM of 14 nm were successfully synthesized by treating the surface with HF and ZnCl2.

However, the synthesis of green ZnSeTe QDs still leads to QDs with a broad emission peak (FWHM: >42 nm). Lattice mismatch between the ZnSeTe core and the ZnSe shell is less problematic for blue QDs with low Te content in the core, but it becomes a very critical issue for green QDs with high Te content. In the core of green ZnSeTe QDs, a high Te content is believed to cause significant lattice mismatch with the ZnSe shell, which can lead to surface traps and broadening of the emission peak.

### REFERENCES

1. Korean Laid-Open Patent No. 10-2023-0013901

### SUMMARY

The present invention has been devised to solve the above problems, and an object of the present invention is to provide green quantum dots comprising: a ZnSeTe core; a gradient layer surrounding the core, wherein the Te/(Te+Se) ratio is reduced compared to the core; and a multi-shell surrounding the gradient layer.

Another object of the present invention is to provide an optical member comprising the quantum dots.

Another object of the present invention is to provide an electronic device comprising the quantum dots.

Another object of the present invention is to provide a method for manufacturing green quantum dots, comprising: (a) forming a ZnSeTe core; (b) reacting the core, a Se-DPP solution, a Te-TOP solution, and a Se-TOP solution to form a gradient layer on the core in which the Te/(Te+Se) ratio is decreased compared to the core; and (c) reacting the ZnSeTe core with the gradient layer formed thereon and a precursor capable of forming a shell to obtain quantum dots with a multi-shell formed around the gradient layer.

One aspect of the present invention provides green quantum dots comprising: a ZnSeTe core; a gradient layer surrounding the core, wherein the Te/(Te+Se) ratio is reduced compared to the core; and a multi-shell surrounding the gradient layer.

The diameter of the core may be 2 to 7 nm.

The ratio of tellurium (Te) to the sum of selenium (Se) and tellurium (Te) (Te/(Se+Te)) in the core may be 10 to 45 mol %.

The gradient layer may include zinc (Zn), tellurium (Te), and selenium (Se).

The thickness of the gradient layer may be 0.5 to 1.5 nm.

The gradient layer may have a Te/(Te+Se) ratio that gradually decreases from the core towards the multi-shell.

However, in the present invention, “the Te/(Te+Se) ratio gradually decreases from the core towards the multi-shell” means that among any two points in the gradient layer, one point closer to the core and farther from the multi-shell has a Te/(Te+Se) ratio that is greater than or equal to, i.e., not smaller than, the other point farther from the core and closer to the multi-shell. This does not necessarily mean that there must be a decreasing trend throughout the entire region as it goes from the core towards the multi-shell, nor does it mean that it decreases at a constant ratio or slope.

The gradient layer may be formed by reacting a Se-DPP solution, a Te-TOP solution, and a Se-TOP solution.

With respect to 1 mole part of the total sum of selenium (Se) in the Se-DPP solution, tellurium (Te) in the Te-TOP solution, and selenium (Se) in the Se-TOP solution, when the sum of selenium (Se) in the Se-DPP solution and tellurium (Te) in the Te-TOP solution is x, x may be 0.2 to 0.95 mole parts.

The Te/(Te+Se) ratio of the gradient layer may be 20 to 23% from the position adjacent to the core to the point that is 65% of the gradient layer thickness, 7 to 20% from the point that is 65% of the gradient layer thickness to the point that is 90% of the gradient layer thickness, and less than 5% from the point that is 90% of the gradient layer thickness to the point that is 100% of the gradient layer thickness.

The multi-shell is composed of a plurality of shells, and each of the plurality of shells may have a composition in which one or more cations selected from the group consisting of zinc (Zn) and magnesium (Mg) are combined with one or more anions selected from the group consisting of sulfur (S) and selenium (Se).

The multi-shell may be a triple shell consisting of a first shell surrounding the ZnSeTe core, a second shell surrounding the first shell, and a third shell surrounding the second shell, and the composition of the first shell/second shell/third shell may be ZnSe/ZnSeS/ZnS.

The diameter of the quantum dot may be 6 to 12 nm.

The full width at half-maximum (FWHM) of the quantum dot may be 30 to 43 nm, and the photoluminescence quantum yield (PLQY) may be 82% or more.

Another aspect of the present invention provides an optical member comprising the quantum dots.

Another aspect of the present invention provides an electronic device comprising the quantum dots.

Another aspect of the present invention provides a method for manufacturing green quantum dots, comprising: (a) forming a ZnSeTe core; (b) reacting the core, a Se-DPP solution, a Te-TOP solution, and a Se-TOP solution to form a gradient layer on the core in which the Te/(Te+Se) ratio is decreased compared to the core; and (c) reacting the ZnSeTe core with the gradient layer formed thereon and a precursor capable of forming a shell to obtain quantum dots with a multi-shell formed around the gradient layer.

The step (a) may include: (a1) primary heating a first Zn precursor solution and then secondary heating it to a higher temperature; and (a2) reacting the heated first Zn precursor solution, a first Se solution, and a first Te solution.

The primary heating may be performed at 110 to 130° C., and the secondary heating may be performed at 280 to 320° C.

The first Se solution and the first Te solution may independently include one or more selected from the group consisting of diphenylphosphine (DPP), trioctylphosphine (TOP), tributylphosphine (TBP), and triphenylphosphine (TPP) as a solvent.

The reaction in step (a2) may be performed for 40 to 100 minutes.

The selenium (Se) concentration of the Se-DPP solution may be 0.3 to 15 mmol/mL, the tellurium (Te) concentration of the Te-TOP solution may be 0.01 to 0.8 mmol/mL, and the selenium (Se) concentration of the Se-TOP solution may be 0.1 to 10 mmol/mL.

The reaction in step (b) may be performed for 40 to 100 minutes.

The step (c) may include: (c1) forming a first shell surrounding the gradient layer; (c2) forming a second shell surrounding the first shell; and (c3) forming a third shell surrounding the second shell.

The composition of the first shell/second shell/third shell may be ZnSe/ZnSeS/ZnS.

The method for manufacturing green quantum dots may further include (d) reacting the quantum dots obtained in step (c) with a Zn stock solution.

The method for manufacturing green quantum dots may further include (e) reacting the product obtained in step (d) with a ligand.

The quantum dots of the present invention can exhibit excellent quantum dot performance by introducing a gradient layer between the ZnSeTe core and the multi-shell, thereby alleviating lattice mismatch and reducing interfacial defects.

The effects of the present invention are not limited to those mentioned above. It should be understood that the effects of the present invention include all effects that can be inferred from the following description.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 shows photo images under ultraviolet (UV) light of ZnSeTe QDs synthesized in Examples and Comparative Examples.

FIGS. 2A to 2D show (A) a diagram illustrating the synthesis process of ZnSeTe QDs with a gradient layer according to an embodiment of the present invention, and (B) normalized PL spectra, (C) absorption spectra, and (D) PLQY (left axis) and FWHM (right axis) graphs according to the x-value of quantum dots prepared in Examples and Comparative Examples.

FIGS. 3A to 3D show (A) scanning transmission electron microscopy (STEM) images and images under UV light, (B) PL spectra, (C) Te/(Te+Se) molar ratio according to the radius of g-core, and (D) atomic mapping images of Te using Cs-corrected scanning transmission electron microscopy-energy dispersive spectroscopy (STEM-EDS) in the g-core synthesized in Example 1.

FIGS. 4A to 4E show the size distribution (scanning transmission electron microscopy (STEM) images) of (A) core, (B) g-core (gradient layer coated core), (C) gC/S (gradient layer coated core/shell), (D) gC/S/S (gradient layer coated core/shell/intermediate shell), and (E) gradient ZnSeTe QDs (g-QDs) synthesized in Example 1.

FIG. 5 shows the normalized fluorescence spectra (PL) of core, gC/S (gradient layer coated core/shell, x=0.8) prepared in Example 1, and C/S (core/shell, x=0) prepared in Comparative Example 1.

FIG. 6 shows scanning transmission electron microscopy (STEM) images of g-core (gradient layer coated core) according to growth time in Example 1.

FIGS. 7A to 7D show atomic mapping images using Cs-corrected scanning transmission electron microscopy (STEM) energy dispersive X-ray spectroscopy (EDS) of g-core (gradient layer coated core) prepared in Example 1.

FIG. 8 shows X-ray photoelectron spectroscopy (XPS) spectra of core, g-core (gradient layer coated core), and gC/S (gradient layer coated core/shell) prepared in Example 1.

FIG. 9 shows X-ray diffraction (XRD) patterns of core and g-core (gradient layer coated core) of Example 1.

FIGS. 10A to 10B shows (A) X-ray diffraction (XRD) patterns and scanning transmission electron microscopy (STEM) images (inset: FFT patterns) of C/S of Comparative Example 1 and gC/S of Example 1, and (B) Raman spectra of core, g-core, gC/S of Example 1, and C/S of Comparative Example 1.

FIGS. 11A to 11D show (A) selected area electron diffraction (SAED) patterns and (B-C) scanning transmission electron microscopy (STEM) images (inset: FFT patterns) of g-core (gradient layer coated core, x=0.8) of Example 1 and QD (x=0) of Comparative Example 1, and (D) size distribution (inset: scanning transmission electron microscopy (STEM) image) of QD (x=0).

FIGS. 12A to 12C shows (A) PL decay curves, (B) PL spectra fitted with two Gaussian linear shapes (green: band-edge luminescence, blue: defect luminescence), and (C) stability test results of final ZnSeTe quantum dots according to the x-value of ZnSeTe quantum dots prepared in Examples and Comparative Examples.

FIG. 13 shows fluorescence spectra (PL) before and after stability tests of quantum dots prepared in Example 1 (x=0.8, g-QDs) and Comparative Example 1 (x=0, QDs).

FIGS. 14A to 14D show (A) a schematic diagram of a QLED prepared in a manufacturing example, (B) voltage-dependent current density (left axis), luminance (right axis) (J-V-L) characteristics, and (C) EQE curves of devices including quantum dots of Example 1 (g-QDs, x=0.8) and Comparative Example 1 (QDs, x=0). (D) Voltage-dependent EL spectrum of a QLED using quantum dots of Example 1 (g-QDs) (inset: image of the device in operation).

FIG. 15 shows voltage-dependent EL spectra of QD without a gradient layer (x=0) of Comparative Example 1 (inset: image of the device in operation).

### DETAILED DESCRIPTION

The advantages and features of the present invention, and methods for achieving them, will become clear with reference to the embodiments described in detail below with the accompanying drawings. However, the present invention is not limited to the embodiments disclosed below but may be implemented in various different forms, and these embodiments are provided merely to make the disclosure of the present invention complete and to fully inform those skilled in the art to which the present invention pertains of the scope of the invention, and the present invention is defined only by the scope of the claims.

In describing the present invention, specific descriptions of related known techniques will be omitted if it is determined that such detailed descriptions may unnecessarily obscure the gist of the present invention. When terms such as “comprises”, “has”, or “consists of” are used in this specification, other components may be added unless “˜only” is explicitly used. In addition, terms such as “comprise” or “have” are intended to specify the presence of features, numbers, steps, components, or combinations thereof described in the specification, and should not be understood as precluding the presence or possibility of adding one or more other features, numbers, steps, components, or combinations thereof. Furthermore, when a component is expressed in the singular, it includes the case where it includes the plural unless explicitly stated otherwise.

In this specification, the Se-DPP solution refers to a solution containing selenium (Se) and diphenylphosphine (DPP).

In this specification, the Te-TOP solution refers to a solution containing tellurium (Te) and trioctylphosphine (TOP).

In this specification, the Se-TOP solution refers to a solution containing selenium (Se) and trioctylphosphine (TOP).

In this specification, the Te/(Te+Se) ratio refers to a molar ratio.

As described above, in conventional ZnSeTe core-based quantum dots, lattice mismatch between the core and the shell caused strain at the interface. Specifically, the core with a larger lattice constant undergoes compressive strain, and the shell with a smaller lattice constant experiences tensile strain. To relieve this strain, various defects such as misfit dislocations and stacking faults occur. These interfacial defects trap electrons and holes, localizing electronic states, which degrades fluorescence characteristics. In particular, in ZnSeTe quantum dots, stacking faults occur when the cubic zinc blende (ZB) crystal structure is mixed with the hexagonal wurtzite (WZ) crystal structure. Therefore, conventional ZnSeTe core-based quantum dots had limited quantum dot performance because lattice mismatch between the core and the shell caused surface traps and broadening of the emission peak.

To address this, the present invention introduces a gradient layer between the ZnSeTe core and the multi-shell to alleviate lattice mismatch and reduce the width of the emission peak, thereby reducing lattice mismatch and interfacial defects.

More specifically, one aspect of the present invention provides green quantum dots comprising: a ZnSeTe core; a gradient layer surrounding the core, wherein the Te/(Te+Se) ratio is reduced compared to the core; and a multi-shell surrounding the gradient layer.

The diameter of the core may be 2 to 7 nm, preferably 2.5 to 6 nm, more preferably 3 to 5 nm, and most preferably 3.5 to 4.5 nm.

If the diameter of the core is less than the lower limit, it may be difficult to achieve a green emission band, and conversely, if it exceeds the upper limit, optical characteristics may be degraded.

The ratio of tellurium (Te) to the sum of selenium (Se) and tellurium (Te) (Te/(Se+Te), molar ratio) in the core may be 10 to 45%, preferably 14 to 40%, more preferably 17 to 35%, and most preferably 20 to 30%.

If the Te/(Se+Te) ratio of the core is less than the lower limit, a violet to cyan emission band with a shorter wavelength than green may be achieved, and conversely, if it exceeds the upper limit, yellow to red emission deviating from green may be accompanied by degradation of optical characteristics.

The central emission wavelength of the ZnSeTe core may be a wavelength corresponding to green-based emission, but is not limited thereto.

The gradient layer may include zinc (Zn), tellurium (Te), and selenium (Se).

The thickness of the gradient layer may be 10 to 50% of the core diameter, preferably 15 to 40%, and more preferably 20 to 30%.

If the thickness of the gradient layer is less than the lower limit compared to the core diameter, it may be difficult to expect a lattice mismatch alleviation effect, and conversely, if it exceeds the upper limit, the characteristics of the quantum dots may be drastically degraded.

The thickness of the gradient layer may be 0.5 to 1.5 nm, preferably 0.6 to 1.3 nm, more preferably 0.65 to 1.2 nm, and most preferably 0.7 to 1 nm.

If the thickness of the gradient layer is less than the lower limit, it may be difficult to expect a lattice mismatch alleviation effect, and conversely, if it exceeds the upper limit, optical characteristics may be limited.

The gradient layer may have a Te/(Te+Se) ratio that gradually decreases from the core towards the multi-shell. In particular, when the Te/(Te+Se) ratio of the gradient layer gradually decreases from the core towards the multi-shell, not only is the degree of lattice mismatch alleviation remarkable, but the stability of the quantum dots is also increased, so that there is no or significantly less degradation of optical characteristics even after long-term storage under extreme conditions.

If, on the other hand, the gradient layer has a Te/(Te+Se) ratio that is reduced compared to the core, but the Te/(Te+Se) ratio is constant within the gradient layer, or does not gradually decrease from the core towards the multi-shell, the degree of lattice mismatch alleviation is insignificant, and optical characteristics may be degraded when the quantum dots are stored under extreme conditions.

More specifically, the gradient layer may have a Te/(Te+Se) ratio that gradually decreases from the core towards the multi-shell, so that the Te/(Te+Se) ratio is 20 to 23% from the position adjacent to the core to the point that is 65% of the gradient layer thickness, 7 to 20% from the point that is 65% of the gradient layer thickness to the point that is 90% of the gradient layer thickness, and less than 5% from the point that is 90% of the gradient layer thickness to the point that is 100% of the gradient layer thickness. In this case, not only are the lattice mismatch alleviation and stacking fault reduction effects between the core and the multi-shell significantly increased, but also the charge loss of devices using them is almost zero, allowing them to operate with excellent performance even at low voltages.

To form a gradient layer in which the Te/(Te+Se) ratio gradually decreases from the core towards the multi-shell as in the present invention, it is important to use selenium (Se) and tellurium (Te) precursors with different reactivities, and specifically, the gradient layer may be formed by reacting a Se-DPP solution, a Te-TOP solution, and a Se-TOP solution.

Since the Se-DPP solution and the Te-TOP solution have much higher reactivity than the Se-TOP solution, alloy reactions primarily occur with Se-DPP and Te-TOP precursors at the core in the initial stage of synthesis. However, as the reaction progresses and the Se-DPP solution and Te-TOP solution are depleted, the TOP in the Se-TOP solution is exchanged with DPP to produce more reactive Se-DPP, gradually forming a selenium-rich phase, thereby surrounding the core with a gradient layer in which the Te/(Te+Se) ratio gradually decreases from the core towards the multi-shell.

That is, in forming the gradient layer, reacting the Se-DPP solution, the Te-TOP solution, and the Se-TOP solution is a very important feature. If other selenium (Se) and tellurium (Te) precursor solutions are used instead, even if a coating layer with a reduced Te/(Te+Se) ratio compared to the core is formed, the Te/(Te+Se) ratio within the gradient layer may be constant or may not gradually decrease from the core towards the multi-shell.

With respect to 1 mole part of the total sum of selenium (Se) in the Se-DPP solution, tellurium (Te) in the Te-TOP solution, and selenium (Se) in the Se-TOP solution, when the sum of selenium (Se) in the Se-DPP solution and tellurium (Te) in the Te-TOP solution is x, x may be 0.2 to 0.95 mole parts, preferably 0.4 to 0.95 mole parts, more preferably 0.5 to 0.9 mole parts, and most preferably 0.7 to 0.87 mole parts.

If the x value is less than the lower limit, it may be difficult to expect a lattice mismatch alleviation effect on the core surface, and conversely, if it exceeds the upper limit, it may be difficult to expect a lattice mismatch alleviation effect with the shell.

The multi-shell may be composed of a plurality of shells, and according to one embodiment, it may be a triple shell consisting of a first shell surrounding the ZnSeTe core, a second shell surrounding the first shell, and a third shell surrounding the second shell, or it may be a quadruple shell in which any one of the first to third shells is doubled. Furthermore, the case where any one of the first to third shells is doubled includes cases where the composition is different, cases where the composition is the same but the type of precursor is different or formed twice, and cases where the method of formation is different.

Each of the plurality of shells may have a composition in which one or more cations selected from the group consisting of zinc (Zn) and magnesium (Mg) are combined with one or more anions selected from the group consisting of sulfur (S) and selenium (Se). Specifically, for example, the first to third shells may be independently formed of combinations such as ZnS, ZnSe, MgS, MgSe.

Preferably, the shells may be formed such that the band gap gradually increases from the inner part adjacent to the core to the outer part, and according to a preferred embodiment, the composition of the first shell/second shell/third shell may be ZnSe/ZnSeS/ZnS.

The diameter of the quantum dot may be 6 to 12 nm, preferably 7 to 10 nm, more preferably 7.5 to 9.5 nm, and most preferably 8 to 9 nm.

If the diameter of the quantum dot is less than the lower limit, optical characteristics may be degraded, and conversely, if it exceeds the upper limit, it may be difficult to achieve a green emission band.

The quantum dot significantly reduces the lattice mismatch between the core and the multi-shell, and as a result of X-ray diffraction (XRD) pattern analysis, the lattice constant may be less than 5.8 Å, preferably less than 5.795 Å, and more preferably less than 5.794 Å.

The quantum dot has a reduced band offset between the core and the gradient layer, and a narrowed bandgap, causing a red shift in PL and absorption spectra, so that the maximum emission wavelength (λmax) may be 520 to 527.5 nm, preferably 522 to 527.3 nm, and more preferably 524 to 527 nm.

The green quantum dots according to the present invention exhibit excellent fluorescence characteristics, with a full width at half-maximum (FWHM) of 30 to 43 nm, preferably 31 to 40 nm, more preferably 32 to 38 nm, and most preferably 33 to 37 nm, and a photoluminescence quantum yield (PLQY) of 82% or more, preferably 85% or more, more preferably 86% or more, and most preferably 88% or more.

According to one embodiment, as a result of X-ray diffraction (XRD) analysis of the green quantum dots, the ratio of peak intensity for the (100) plane to peak intensity for the (111) plane is 0.74 or less, preferably 0.73 or less, and more preferably 0.71 or less.

According to another embodiment, as a result of X-ray diffraction (XRD) analysis of the green quantum dots, the ratio of peak intensity for the (101) plane to peak intensity for the (111) plane is 0.66 or less, preferably 0.63 or less, more preferably 0.59 or less, and most preferably 0.50 or less.

According to yet another embodiment, as a result of X-ray diffraction (XRD) analysis of the green quantum dots, the ratio of peak intensity for the (103) plane to peak intensity for the (220) plane is 0.25 or less, preferably 0.24 or less. Or the ratio of peak intensity for the (103) plane to peak intensity for the (311) plane is 0.38 or less, preferably 0.35 or less.

According to yet another embodiment, as a result of X-ray diffraction (XRD) analysis of the green quantum dots, one or more of the following conditions are satisfied: the ratio of peak intensity for the (100) plane to peak intensity for the (111) plane is 0.73 or less, the ratio of peak intensity for the (101) plane to peak intensity for the (111) plane is 0.63 or less, the ratio of peak intensity for the (103) plane to peak intensity for the (220) plane is 0.24 or less, and the ratio of peak intensity for the (103) plane to peak intensity for the (311) plane is 0.35 or less, provided that it is preferable to satisfy two or more, more preferable to satisfy three or more, and most preferable to satisfy all four.

According to another embodiment, the interplanar spacing derived from the FFT pattern analysis of the STEM image of the green quantum dots is 0.31 to 0.33 nm.

It is very significant that such a structure is confirmed by XRD and FFT analysis, as satisfying at least one of the above conditions for peak intensity ratios by XRD analysis and additionally satisfying the interplanar spacing requirement of the FFT pattern means that the gradient layer can significantly suppress misfit dislocations and stacking faults occurring at the core/shell interface, thereby greatly reducing defect-induced optical property degradation compared to general ZnSeTe/ZnSe QDs.

Another aspect of the present invention provides an optical member comprising the quantum dots.

Another aspect of the present invention provides an electronic device comprising the quantum dots.

The electronic device may be various displays, light sources, lighting, personal computers (e.g., mobile personal computers), mobile phones, digital cameras, electronic notebooks, electronic dictionaries, electronic game consoles, medical devices (e.g., electronic thermometers, blood pressure monitors, blood glucose meters, pulse measurement devices, pulse wave measurement devices, electrocardiogram display devices, ultrasound diagnostic devices, endoscope display devices), fish finders, various measuring instruments, meters (e.g., meters for vehicles, aircraft, ships), and projectors.

The quantum dots according to the present invention can also be used as a color conversion layer, and thus another aspect of the present invention is for example, a display device comprising: an organic light emitting diode (OLED); and a color conversion layer comprising quantum dots according to various embodiments of the present invention.

Another aspect of the present invention provides a method for manufacturing green quantum dots, comprising: (a) forming a ZnSeTe core; (b) reacting the core, a Se-DPP solution, a Te-TOP solution, and a Se-TOP solution to form a gradient layer on the core in which the Te/(Te+Se) ratio is decreased compared to the core; and (c) reacting the ZnSeTe core with the gradient layer formed thereon and a precursor capable of forming a shell to obtain quantum dots with a multi-shell formed around the gradient layer.

### (a) Step of Forming a ZnSeTe Core

The step (a) is a step of forming a ZnSeTe core, which can be performed by reacting a first Zn precursor solution, a first Se solution, and a first Te solution.

The step (a) may include: (a1) primary heating a first Zn precursor solution and then secondary heating it to a higher temperature; and (a2) reacting the heated first Zn precursor solution, a first Se solution, and a first Te solution.

The first Zn precursor solution may include oleic acid (OA), 1-octadecene (ODE), or a mixture thereof as a solvent.

The first Zn precursor may include one or more selected from the group consisting of Zn metal, ZnO, zinc chloride, zinc stearate, and zinc acetate (Zn(OAc)2).

The primary heating may be performed at 110 to 130° C., and the secondary heating may be performed at 280 to 320° C.

The first Se solution may include one or more selected from the group consisting of diphenylphosphine (DPP), trioctylphosphine (TOP), tributylphosphine (TBP), and triphenylphosphine (TPP) as a solvent, preferably diphenylphosphine (DPP).

The first Te solution may include one or more selected from the group consisting of diphenylphosphine (DPP), trioctylphosphine (TOP), tributylphosphine (TBP), and triphenylphosphine (TPP) as a solvent, preferably trioctylphosphine (TOP).

The ratio of tellurium (Te) to the sum of selenium (Se) and tellurium (Te) (Te/(Se+Te)) in the core may be 10 to 45 mol %, preferably 14 to 40 mol %, more preferably 17 to 35 mol %, and most preferably 20 to 30 mol %.

The reaction in step (a2) may be performed for 40 to 100 minutes, preferably 43 to 90 minutes, more preferably 45 to 80 minutes, and most preferably 50 to 70 minutes.

If the reaction time of step (a2) is less than the lower limit, the stability of the core may be drastically degraded, and conversely, if it exceeds the upper limit, the optical characteristics of the quantum dot may be degraded.

(b) Step of Obtaining a ZnSeTe Core with a Gradient Layer Formed Thereon by Reacting the Core, a Second Zn Precursor Solution, a Se-DPP Solution, a Te-TOP Solution, and a Se-TOP Solution

The step (b) is a step of obtaining a ZnSeTe core with a gradient layer formed thereon by reacting the core, a second Zn precursor solution, a Se-DPP solution, a Te-TOP solution, and a Se-TOP solution.

The second Zn precursor may include one or more selected from the group consisting of Zn metal, ZnO, zinc chloride, zinc stearate, and zinc acetate (Zn(OAc)2).

The second Zn precursor solution may include oleic acid (OA), 1-octadecene (ODE), or a mixture thereof as a solvent.

With respect to 1 mole part of the total sum of selenium (Se) in the Se-DPP solution, tellurium (Te) in the Te-TOP solution, and selenium (Se) in the Se-TOP solution, when the sum of selenium (Se) in the Se-DPP solution and tellurium (Te) in the Te-TOP solution is x, x may be 0.2 to 0.95 mole parts, preferably 0.4 to 0.95 mole parts, more preferably 0.5 to 0.9 mole parts, and most preferably 0.7 to 0.87 mole parts.

The selenium (Se) concentration of the Se-DPP solution may be 0.3 to 15 mmol/mL, preferably 0.6 to 10 mmol/mL, more preferably 0.8 to 5 mmol/mL, and most preferably 1 to 3 mmol/mL.

The tellurium (Te) concentration of the Te-TOP solution may be 0.01 to 0.8 mmol/mL, preferably 0.05 to 0.7 mmol/mL, more preferably 0.08 to 0.6 mmol/mL, and most preferably 0.1 to 0.5 mmol/mL.

The selenium (Se) concentration of the Se-TOP solution may be 0.1 to 10 mmol/mL, preferably 0.5 to 8 mmol/mL, more preferably 0.7 to 6 mmol/mL, and most preferably 1 to 3 mmol/mL.

It is preferable that the selenium (Se) or tellurium (Te) concentration in the Se-DPP solution, Te-TOP solution, and Se-TOP solution satisfy the above range, as exceeding this range would degrade the stability of the gradient layer.

The reaction in step (b) may be performed for 40 to 100 minutes, preferably 43 to 90 minutes, more preferably 45 to 80 minutes, and most preferably 50 to 70 minutes.

If the reaction time of step (b) is less than the lower limit, it may be difficult to expect a lattice mismatch alleviation effect, and conversely, if it exceeds the upper limit, the optical characteristics of the quantum dot may be degraded.

(c) Step of Obtaining Green Quantum Dots with a Shell Formed Around the Gradient Layer by Reacting the ZnSeTe Core with the Gradient Layer Formed Thereon and a Precursor Capable of Forming a Shell

The step (c) is a step of obtaining green quantum dots with a shell formed around the gradient layer by reacting the ZnSeTe core with the gradient layer formed thereon and a precursor capable of forming a shell.

The shell surrounding the gradient layer may be a multi-shell composed of a plurality of shells, and according to one embodiment, it may be a triple shell consisting of a first shell surrounding the gradient layer, a second shell surrounding the first shell, and a third shell surrounding the second shell, or it may be a quadruple shell in which any one of the first to third shells is doubled.

Each of the plurality of shells may have a composition in which one or more cations selected from the group consisting of zinc (Zn) and magnesium (Mg) are combined with one or more anions selected from the group consisting of sulfur (S) and selenium (Se), and specifically, for example, the first to third shells may be independently formed of combinations such as ZnS, ZnSe, MgS, MgSe.

The precursor capable of forming the shell may include a precursor for the cation and a precursor for the anion.

Preferably, the shells may be formed such that the band gap gradually increases from the inner part adjacent to the core to the outer part, and specifically, the composition of the first shell/second shell/third shell may be ZnSe/ZnSeS/ZnS.

According to a preferred embodiment of the present invention, step (c) may include: (c1) forming a first shell surrounding the gradient layer; (c2) forming a second shell surrounding the first shell; and (c3) forming a third shell surrounding the second shell.

Step (c1) may be performed by reacting the ZnSeTe core with the gradient layer formed thereon, a third Zn precursor solution, and a second Se solution to form a first shell with a ZnSe composition.

The third Zn precursor may include one or more selected from the group consisting of Zn metal, ZnO, zinc chloride, zinc stearate, and zinc acetate (Zn(OAc)2).

The third Zn precursor solution may include oleic acid (OA), 1-octadecene (ODE), or a mixture thereof as a solvent.

The second Se solution may include one or more selected from the group consisting of diphenylphosphine (DPP), trioctylphosphine (TOP), tributylphosphine (TBP), and triphenylphosphine (TPP) as a solvent, preferably trioctylphosphine (TOP).

The reaction in step (c1) may be performed for 40 to 100 minutes, preferably 43 to 90 minutes, more preferably 45 to 80 minutes, and most preferably 50 to 70 minutes.

If the reaction time of step (c1) is less than the lower limit, the stability of the quantum dot may be degraded, and conversely, if it exceeds the upper limit, the optical characteristics of the quantum dot may be degraded.

Step (c2) may be performed by reacting the ZnSeTe core with the first shell formed thereon, a fourth Zn precursor solution, a third Se solution, and a first S solution to form a second shell with a ZnSeS composition.

The fourth Zn precursor may include one or more selected from the group consisting of Zn metal, ZnO, zinc chloride, zinc stearate, and zinc acetate (Zn(OAc)2).

The fourth Zn precursor solution may include oleic acid (OA), 1-octadecene (ODE), or a mixture thereof as a solvent.

The third Se solution may include one or more selected from the group consisting of diphenylphosphine (DPP), trioctylphosphine (TOP), tributylphosphine (TBP), and triphenylphosphine (TPP) as a solvent, preferably trioctylphosphine (TOP).

The first S solution may include one or more selected from the group consisting of diphenylphosphine (DPP), trioctylphosphine (TOP), tributylphosphine (TBP), and triphenylphosphine (TPP) as a solvent, preferably trioctylphosphine (TOP).

The reaction in step (c2) may be performed for 40 to 100 minutes, preferably 43 to 90 minutes, more preferably 45 to 80 minutes, and most preferably 50 to 70 minutes.

If the reaction time of step (c2) is less than the lower limit, the stability of the quantum dot may be degraded, and conversely, if it exceeds the upper limit, the optical characteristics of the quantum dot may be degraded.

Step (c3) may be performed by reacting the ZnSeTe core with the second shell formed thereon, a fifth Zn precursor solution, and a second S solution to form a third shell with a ZnS composition.

The fifth Zn precursor may include one or more selected from the group consisting of Zn metal, ZnO, zinc chloride, zinc stearate, and zinc acetate (Zn(OAc)2).

The fifth Zn precursor solution may include oleic acid (OA), 1-octadecene (ODE), or a mixture thereof as a solvent.

The second S solution may include one or more selected from the group consisting of diphenylphosphine (DPP), trioctylphosphine (TOP), tributylphosphine (TBP), and triphenylphosphine (TPP) as a solvent, preferably trioctylphosphine (TOP).

The reaction in step (c3) may be performed for 40 to 100 minutes, preferably 43 to 90 minutes, more preferably 45 to 80 minutes, and most preferably 50 to 70 minutes.

If the reaction time of step (c3) is less than the lower limit, the stability of the quantum dot may be degraded, and conversely, if it exceeds the upper limit, the optical characteristics of the quantum dot may be degraded.

(d) Step of Reacting the Quantum Dots Obtained in Step (c) with a Zn Stock Solution

The method for manufacturing green quantum dots of the present invention may further include step (d) of reacting the quantum dots obtained in step (c) with a Zn stock solution to remove surface defects of the quantum dots after step (c).

The Zn stock solution may include one or more Zn precursors selected from the group consisting of Zn metal, ZnO, zinc chloride, zinc stearate, and zinc acetate (Zn(OAc)2), and may include oleic acid (OA), 1-octadecene (ODE), or a mixture thereof as a solvent.

The reaction in step (d) may be performed for 40 to 100 minutes, preferably 43 to 90 minutes, more preferably 45 to 80 minutes, and most preferably 50 to 70 minutes.

(e) Step of Reacting the Product Obtained in Step (d) with a Ligand

The method for manufacturing green quantum dots of the present invention may further include step (e) of reacting the product obtained in step (d) with a ligand to improve the efficiency and stability of the quantum dots through additional ligand adsorption after step (d).

The ligand may be one or more selected from the group consisting of 1-butanethiol, 1-hexanethiol, OTT, 1-undecanethiol, decanethiol, 1-dodecanethiol (DDT), 1-hexadecanethiol, 1-octadecanethiol, amylamine, butylamine, hexylamine, heptylamine, octylamine, nonylamine, decylamine, didecylamine, tetradecylamine, hexadecylamine, octadecylamine, and trihexylamine, preferably 1-dodecanethiol (DDT).

The reaction in step (e) may be performed at 180 to 270° C. for 5 to 60 minutes, preferably at 200 to 250° C. for 10 to 40 minutes.

Hereinafter, the present invention will be described in more detail through examples, but the scope and content of the present invention are not limited or restricted by the following examples.

### EXAMPLES

### Raw Materials

Zinc acetate (Zn(OAc)2, 99.99%), tellurium (99.8%, powder), oleic acid (OA, 90%), 1-octadecene (1-ODE, 90%), tri-n-octylphosphine (TOP, 97%), sulfur (99.98%, powder), zinc stearate (Zn(St)2, technical grade), 1-dodecanethiol (1-DDT, ≥98%), magnesium acetate tetrahydrate (Mg(OAc)2·4H2O, ≥99/6), tetramethylammonium hydroxide pentahydrate (TMAH, ≥97%), and poly(9-vinylcarbazole) (PVK) were purchased from Aldrich. Selenium (99.999%, powder) was purchased from Alfa Aesar, and diphenylphosphine (DPP, >98%) was purchased from Lake Materials. Ethanol (>99.9%), acetone (>99.8%), n-hexane (>95.0%), dimethyl sulfoxide (DMSO, >99.5%), and ethyl acetate (>99.5%) were purchased from Daejung Chemicals. Indium tin oxide (ITO) glass substrates were purchased from INTREE, and poly(3,4-ethylenedioxythiophene):poly(styrenesulfonate) (PEDOT, Al4083) was purchased from Ossila. All chemicals were used without further purification.

### Example 1. Synthesis of Green ZnSeTe ODs with a Gradient Layer

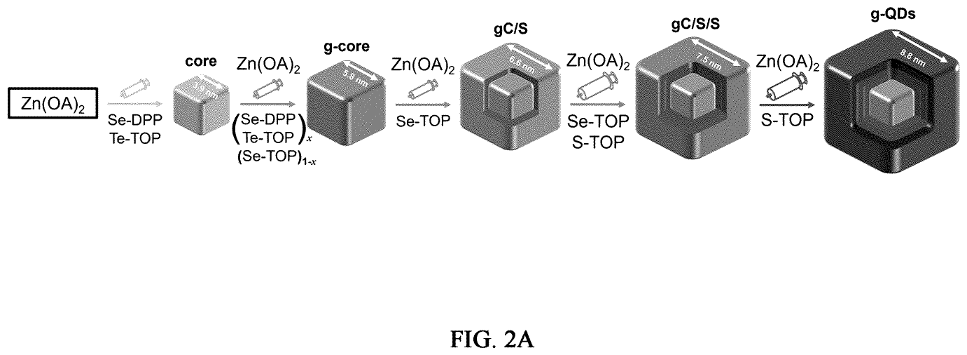

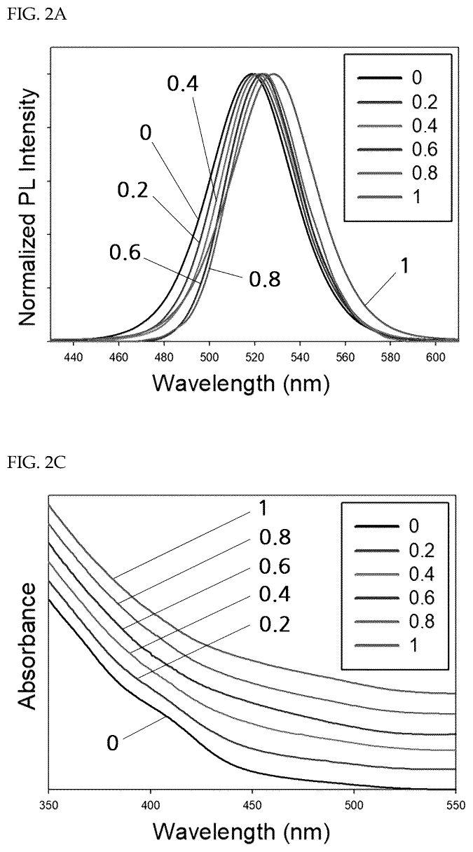

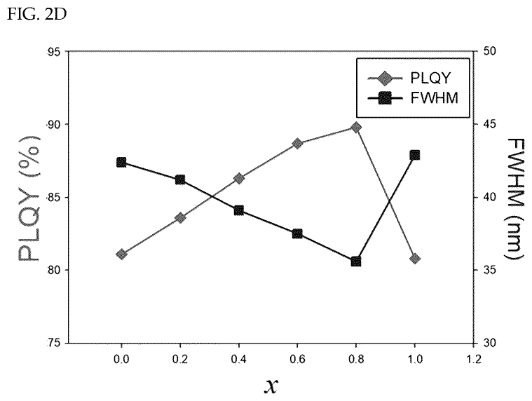

FIG. 2 (a) is a diagram showing the synthesis process of ZnSeTe QDs with a gradient layer according to an embodiment of the present invention. Hereinafter, the manufacturing process of green quantum dots will be described with reference to FIG. 2(a).

### (1) Formation of ZnSeTe Core (‘Core’)

A first Zn precursor solution, prepared by mixing and stirring Zn(OAc)2 (2.53 mmol), OA (oleic acid, 2 mL), and ODE (octadecene, 15 mL) in a 3-neck flask, was slowly heated to 120° C. under vacuum, and then, when the pressure reached 13 mTorr, the mixture was further heated to 300° C. under an Ar flow.

A first Se solution (Se-DPP) was prepared by adding 1 mmol Se to 0.5 mL diphenylphosphine (DPP) at 130° C., and a first Te solution (Te-TOP) was prepared by adding 0.265 mmol Te to 1.2 mL TOP (tri-n-octylphosphine).

Then, Se-DPP and Te-TOP were rapidly injected sequentially into the flask containing the secondarily heat-treated first Zn precursor solution, and reacted for 60 minutes to form a ZnSeTe core.

(2) Formation of ‘g-Core’ (or ‘g-ZnSeTe’) Coated with a Gradient Layer

Zinc oleate was prepared by mixing Zn(OAc)2 (24 mmol), OA (oleic acid, 16 mL), and ODE (octadecene, 9.6 mL) and degassing in the same manner, then maintaining at 180° C. under an Ar flow.

To grow a gradient layer on the ZnSeTe core, the ZnSeTe core and zinc oleate (3.2 mL) prepared at 180° C. were injected, and Se-DPP (0.8 mmol Se in 0.4 mL DPP, 2 mmol/mL), Te-TOP (0.212 mmol Te in 0.96 mL TOP, 0.22 mmol/mL), and Se-TOP (0.253 mmol Se in 0.2 mL TOP, 1.265 mmol/mL) were sequentially injected and reacted for 60 minutes to obtain a g-Core (x=0.8).

(3) g-Core Coated with ZnSe Inner Shell (‘gC/S’ or ‘g-ZnSeTe/ZnSe’)

After slowly injecting the ZnSeTe core with the gradient layer formed thereon, the zinc oleate (3.2 mL), and Se-TOP (1.265 mmol Se in 1 mL TOP), they were reacted for 60 minutes to grow a ZnSe inner shell (first shell) to obtain gC/S.

(4) g-Core Coated with ZnSeS Intermediate Shell (gC/S/S or g-ZnSeTe/ZnSe/ZnSeS)

Next, the zinc oleate (6.4 mL), Se-TOP (1.265 mmol Se in 1 mL TOP), and S-TOP (1.265 mmol S in 1 mL TOP) were simultaneously injected into the ZnSe inner shell formation solution and reacted for 60 minutes to create a ZnSeS intermediate shell (second shell) to obtain gC/S/S.

(5) g-Core Coated with ZnS Outer Shell (‘g-QDs’ or ‘g-ZnSeTe/ZnSe/ZnSeS/ZnS’)

Thereafter, to form a ZnS outer shell (third shell), zinc oleate (6.4 mL) and S-TOP (2.53 mmol S in 2 mL TOP) were slowly injected into the ZnSeS intermediate shell formation solution and reacted for 60 minutes.

Finally, Zn(St)2 (3.95 mmol) and ODE (7.5 mL) were injected into the solution where the third shell was formed, reacted at 270° C. for 30 minutes, then DDT (1.5 mL) was injected at 230° C. and reacted for another 30 minutes.

Then, to stop the reaction, the flask was cooled to room temperature using excess acetone, and the generated ZnSeTe QDs were purified by centrifugation with excess acetone, dispersed in hexane, and then repeatedly centrifuged with ethanol and re-dispersed in hexane to obtain g-QDs, which were stored in a refrigerator for future use.

### Examples 2 to 4. Synthesis of Green ZnSeTe ODs with a Gradient Layer

Green quantum dots were prepared by the same method as in Example 1, except that the amounts of Se-DPP solution, Te-TOP solution, and Se-TOP solution used in the gradient layer formation step were adjusted such that when x is the sum of selenium (Se) in the Se-DPP solution and tellurium (Te) in the Te-TOP solution with respect to 1 mole part of the total sum of selenium (Se) in the Se-DPP solution, tellurium (Te) in the Te-TOP solution, and selenium (Se) in the Se-TOP solution, x was changed to 0.2 mole parts (Example 2), 0.4 mole parts (Example 3), and 0.6 mole parts (Example 4).

### Comparative Example 1. ZnTeSe/ZnSe OD (C/S, g-ODs (x=0))

Green quantum dots were prepared by the same method as in Example 1, except that the amounts of Se-DPP solution, Te-TOP solution, and Se-TOP solution used in the gradient layer formation step were adjusted such that when x is the sum of selenium (Se) in the Se-DPP solution and tellurium (Te) in the Te-TOP solution with respect to 1 mole part of the total sum of selenium (Se) in the Se-DPP solution, tellurium (Te) in the Te-TOP solution, and selenium (Se) in the Se-TOP solution, x was changed to 0 mole parts.

### Comparative Example 2. ZnTeSe/ZnSe OD (g-ODs (x=1))

Green quantum dots were prepared by the same method as in Example 1, except that the amounts of Se-DPP solution, Te-TOP solution, and Se-TOP solution used in the gradient layer formation step were adjusted such that when x is the sum of selenium (Se) in the Se-DPP solution and tellurium (Te) in the Te-TOP solution with respect to 1 mole part of the total sum of selenium (Se) in the Se-DPP solution, tellurium (Te) in the Te-TOP solution, and selenium (Se) in the Se-TOP solution, x was changed to 1 mole part.

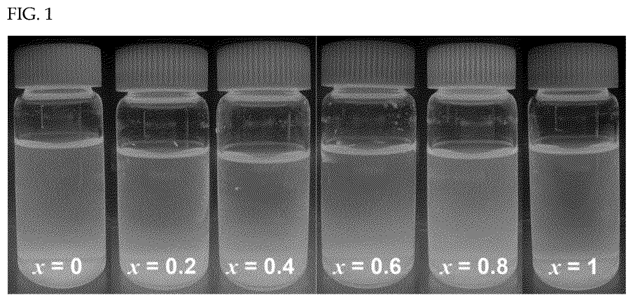

In Examples and Comparative Examples, to obtain green light-emitting quantum dots, the Te/Se precursor ratio in the core with a diameter of 3.9 nm was set to 26.5 mol %, and a gradient layer was formed by injecting (Se-DPP and Te-TOP)x and (Se-TOP)1−x on the core according to various x values (0≤x≤1), and their optical characteristics are shown in FIG. 1 and Table 1.

TABLE 1

| x | 0 | 0.2 | 0.4 | 0.6 | 0.8 | 1 |
|---|---|---|---|---|---|---|
| λₘₐₓ (nm) | 519 | 520 | 522 | 523 | 526 | 528 |
| PLQY (%) | 81.1 | 83.6 | 86.3 | 88.7 | 89.8 | 80.8 |
| FWHM (nm) | 42.4 | 41.2 | 39.1 | 37.5 | 35.6 | 42.9 |

### Manufacturing Example 1. Fabrication of Quantum Dot Light Emitting Diode (OLED) Device Using ZnSeTe ODs

### (1) Fabrication of Quantum Dot Light Emitting Diode (QLED) Device

After ultrasonically cleaning glass substrates with acetone and isopropyl alcohol for 10 minutes each, they were UV-ozone treated for 20 minutes to increase the hydrophilicity of the substrate. For the hole injection layer (HIL), PEDOT (Al4083) was spin-coated at 3000 rpm for 60 seconds and heat-treated at 150° C. for 30 minutes. For the hole transport layer (HTL), poly(9-vinylcarbazole) (PVK) dissolved in chlorobenzene was spin-coated at 3000 rpm for 60 seconds and then heat-treated at 150° C. for 30 minutes.

To compare the performance of QDs, ZnSeTe QDs with a gradient layer and ZnSeTe QDs without a gradient layer were dispersed in hexane at the same concentration (O.D.=2.0) and used as the emissive layer (EML). These QDs were spin-coated at 3000 rpm for 20 seconds and heat-treated at 70° C. for 10 minutes. Thereafter, ZnMgO nanoparticles were spin-coated on the EML at 3000 rpm for 60 seconds. All spin-coating and heat treatment processes were performed under a nitrogen atmosphere. Finally, an aluminum (Al) cathode was thermally evaporated to complete the QLED fabrication.

ZnMgO nanoparticles were obtained by mixing Zn(OAc)2 (8.15 mmol), Mg(OAc)2·4H2O (1.85 mmol), and DMSO (40 mL) in a 100 mL flask, stirring for less than 5 minutes, then injecting a TMAH solution (10 mmol TMAH dissolved in 10 mL ethanol) for 1 minute, and reacting for 1 hour. The generated ZnMgO nanoparticles were purified by repeated centrifugation with excess ethyl acetate and then re-dispersed in ethanol, and the finally prepared nanoparticles were stored in a refrigerator.

### Experimental Example 1. Characterization Methods

The fluorescence spectra (PL) and photoluminescence quantum yield (PLQY) of the synthesized QDs were measured using a spectrofluorometer (FP-8500, Jasco) with an integrating sphere. The absorption spectra of the QDs were obtained using a UV-vis spectrophotometer (V-730, Jasco). Scanning transmission electron microscopy (STEM) images, selected area electron diffraction (SAED) patterns, and atomic mapping using Cs-corrected scanning transmission electron microscopy (STEM)-energy dispersive X-ray spectroscopy (EDS) were obtained with a JEM-ARM 200F (NEOARM) operating at 200 kV. TEM samples were prepared by depositing sufficiently diluted QDs in hexane onto 200-mesh holey carbon-supported copper grids. The elemental composition and bonding state of the QDs were investigated using X-ray photoelectron spectroscopy (XPS) (K-alpha, Thermo Fisher Scientific), using aluminum Ka as the X-ray source. X-ray diffraction (XRD) patterns were obtained using an X-ray diffractometer (Ultima IV, Rigaku) with Cu/Kα1 (λ=1.54059 Å) radiation. For XPS and XRD measurements, the synthesized QDs were degassed in a vacuum oven for 24 hours and then prepared in powder form. Raman spectra were measured using a Raman spectrometer (LabRam Aramis, Horiba Jobin Yvon) with a CCD detector and a 532 nm Nd laser at a power of approximately 0.8 mW. Time-resolved emission spectra were obtained with an excitation beam of 405 nm (LDH-D-C-405 laser diode, PicoQuant) and detected using a photomultiplier tube (PMA-C182-N-M, PicoQuant). The EL characteristics of the QLED device were characterized using a Transient electroluminescence (EL) measurement system (M6300, McScience), using a spectroradiometer (PR-655, Photo Research Inc.) and a source meter (Keithley 2401, Keithley Instruments) as equipment.

### Experimental Example 2

FIG. 2 (A) is a diagram illustrating the synthesis process of ZnSeTe QDs with a gradient layer according to an embodiment of the present invention, and (B), (C), and (D) show normalized PL spectra (B), absorption spectra (C), and PLQY (left axis) and FWHM (right axis) graphs (D) of quantum dots prepared in Examples and Comparative Examples according to the x-value, respectively.

As shown in FIG. 2, as the x-value increased in the quantum dots prepared in the Examples and Comparative Examples, the amount of Te in the gradient layer increased, decreasing the band offset between the core and the gradient layer and narrowing the bandgap, resulting in a red shift in the PL and absorption spectra, so that the maximum wavelength (λmax) shifted from 519 nm to 528 nm (FIG. 2(B-C)). In addition, as the x-value increased from 0 to 0.8, the FWHM gradually decreased and the PLQY gradually increased, but at x-values exceeding 0.8, both FWHM and PLQY decreased, and the g-QD synthesized in Example 1 (x=0.8) showed an FWHM of 36 nm and a PLQY of 90%, surpassing the performance of previously reported green ZnSeTe QDs (FIG. 2(D)).

### Experimental Example 3

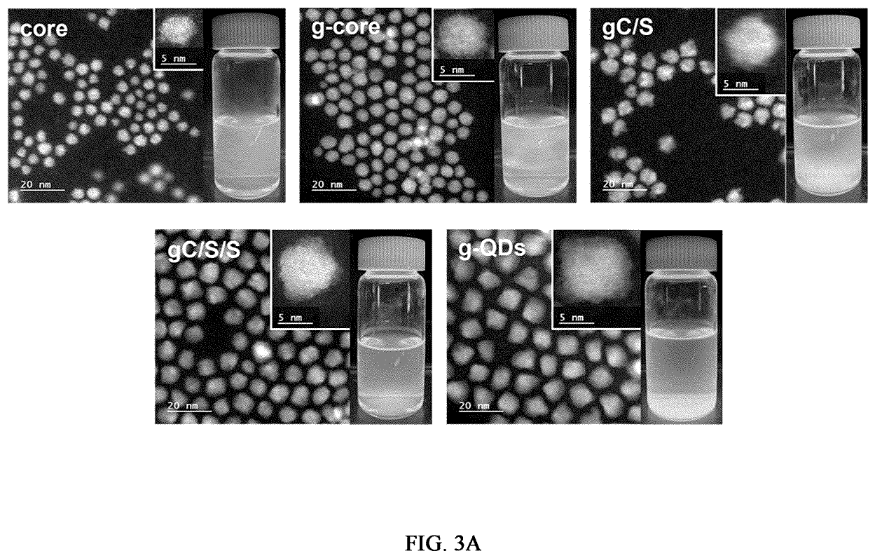

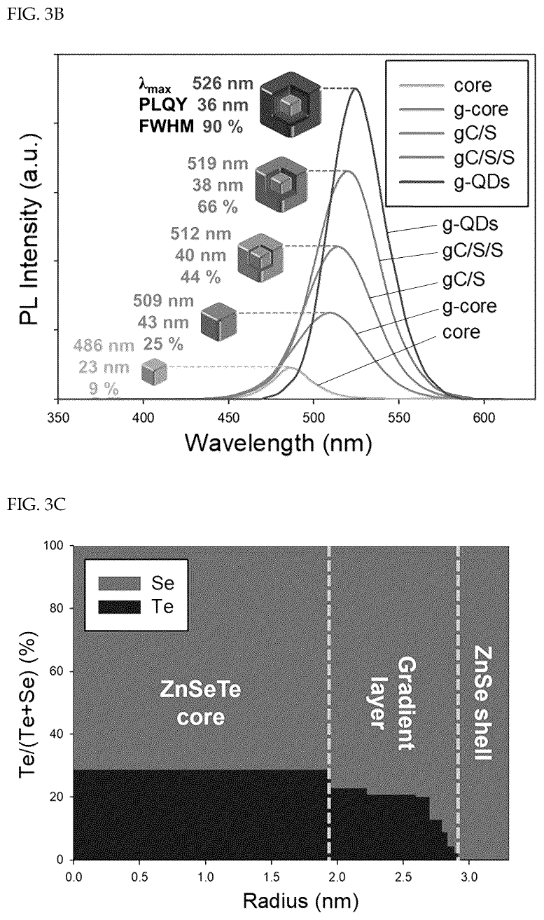

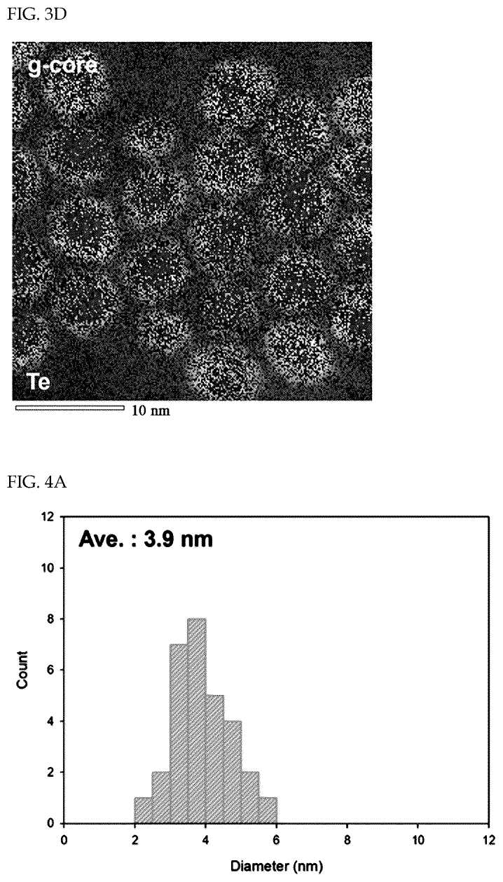

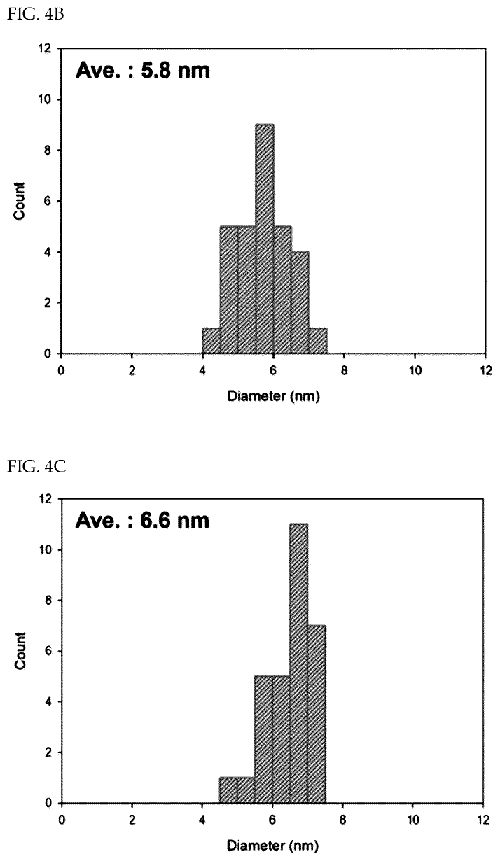

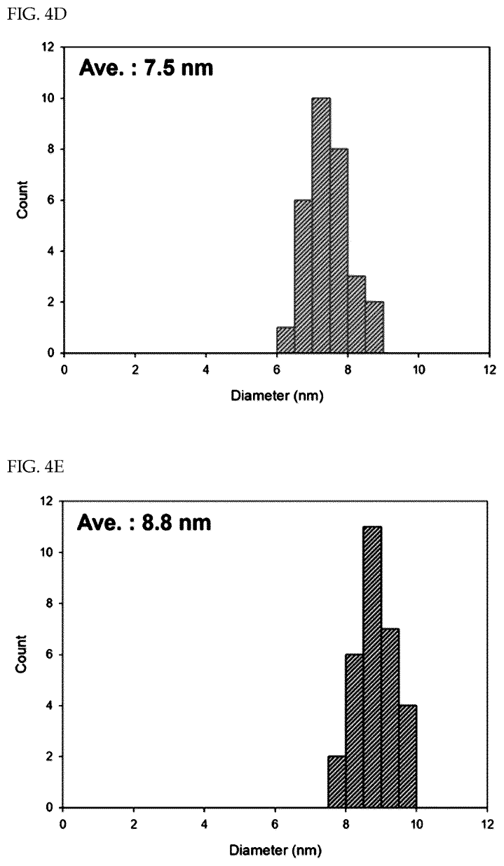

To explain the unprecedented PLQY and FWHM of the g-QD synthesized in the Example (x=0.8), a comprehensive analysis of each synthesis step was performed, and the results are shown in FIGS. 3A to 3D and 4.

FIG. 3 shows (A) scanning transmission electron microscopy (STEM) images and images under UV light, (B) PL spectra, (c) Te/(Te+Se) molar ratio according to the radius of g-core, and (D) atomic mapping images of Te using Cs-corrected scanning transmission electron microscopy-energy dispersive spectroscopy (STEM-EDS) in the g-core synthesized in Example 1, for ZnSeTe QDs and their precursors prepared at each synthesis step.

FIG. 4 shows the size distribution (scanning transmission electron microscopy (STEM) images) of (A) core, (B) g-core (gradient layer coated core), (C) gC/S (gradient layer coated core/shell), (D) gC/S/S (gradient layer coated core/shell/intermediate shell), and (E) gradient ZnSeTe QDs (g-QDs) synthesized in Example 1.

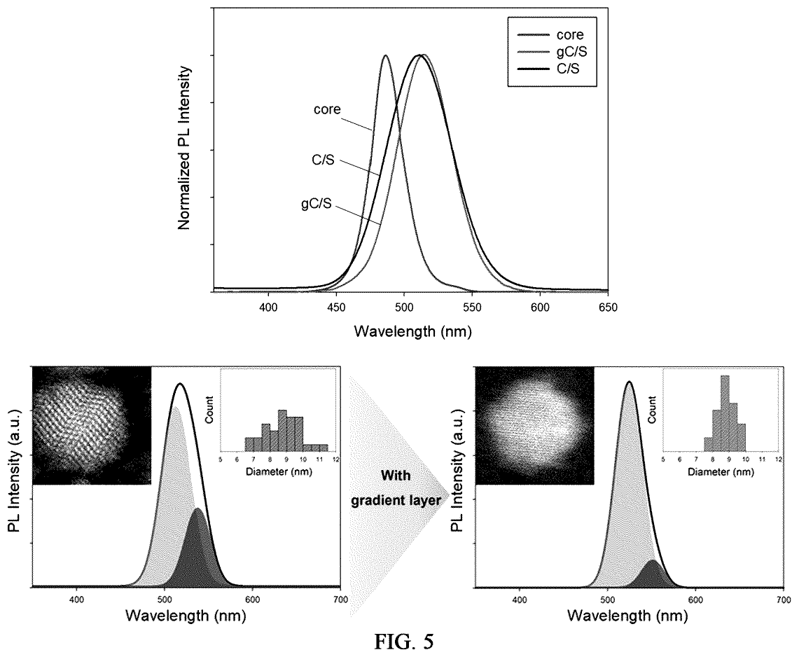

FIG. 5 shows the normalized fluorescence spectra (PL) of core, gC/S (gradient layer coated core/shell, x=0.8) prepared in Example 1, and C/S (core/shell, x=0) prepared in Comparative Example 1.

As shown in FIGS. 3, 4, and 5, as the synthesis progressed, the formation of each gradient layer and shell resulted in a more distinct cubic zinc blende structure and a uniform size distribution (FIGS. 3(A) and 4). In addition, the luminescence under UV light became increasingly clearer and greener, exhibiting an accurate green color (526 nm) in the final g-QD (FIGS. 3(A) and (B)). The synthesized core showed a narrow PL spectrum with an FWHM of 23 nm, but in the case of ZnTeSe/ZnSe QD (C/S, x=0) of Comparative Example 1, where a ZnSe inner shell was directly formed, the emission peak was significantly broadened due to lattice mismatch between the ZnSeTe core and the ZnSe shell due to the difference in ionic radii of Se2- and Te2-, and the FWHM increased to 49 nm (FIG. 5).

In particular, gC/S (x=0.8) of Example 1 had a narrower emission peak (FWHM of about 40 nm) compared to Comparative Example 1 (C/S, FIG. 5) without a gradient layer when a ZnSe inner shell was grown on the g-core, which is because the gradient layer formed using the difference in reactivity of Se-DPP, Se-TOP, and Te-TOP in Example 1 alleviated the lattice mismatch.

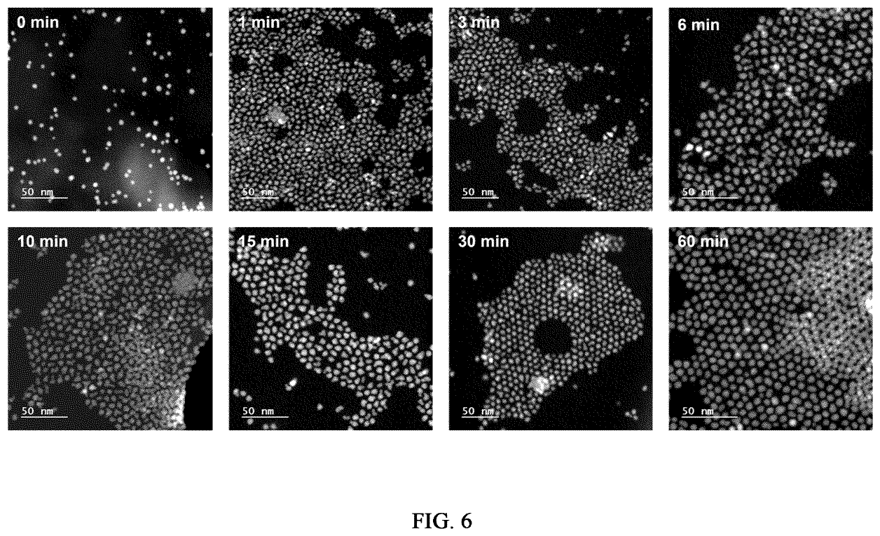

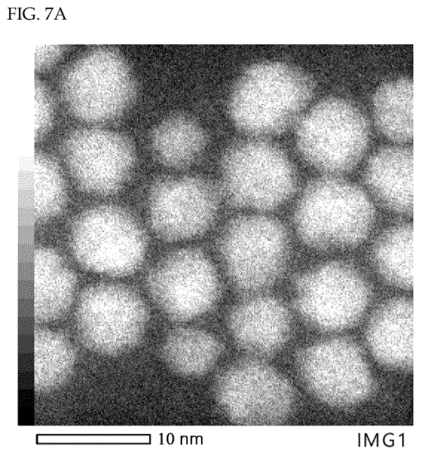

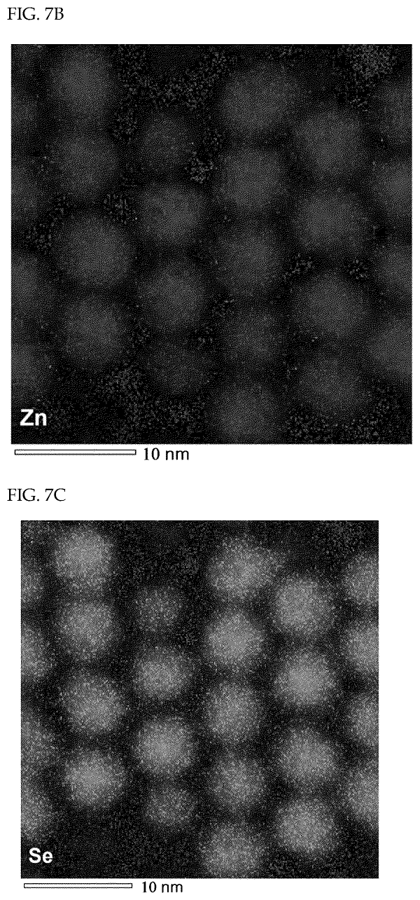

Meanwhile, the growth process of the gradient layer on the core (g-core) was monitored over various times using Cs-corrected scanning transmission electron microscopy (STEM)-energy dispersive X-ray spectroscopy (EDS) to determine the average radius and chemical composition, and the results are shown in FIG. 6 and Table 2. Atomic mapping of the g-core was performed using Cs-corrected scanning transmission electron microscopy-energy dispersive spectroscopy (STEM-EDS) to directly visualize the elements within the gradient layer, and the results are shown in FIGS. 7A to 7D.

FIG. 6 shows scanning transmission electron microscopy (STEM) images of g-core (gradient layer coated core) according to growth time in Example 1.

TABLE 2

| Reaction | Radius by | Te/(Te + Se) by | Te/(Te + Se) at |
|---|---|---|---|
| Time (min) | TEM (nm) | EDS (%) | interval (%) |
| 0 (core) | 1.95 | 28.60 | 22.74 |
| 1 | 2.22 | 26.71 | 20.63 |
| 3 | 2.59 | 24.46 | 19.92 |
| 6 | 2.70 | 23.95 | 12.71 |
| 10 | 2.79 | 22.84 | 8.73 |
| 15 | 2.83 | 22.25 | 4.25 |
| 30 | 2.89 | 21.24 | 1.93 |
| 60 (g-core) | 2.92 | 20.62 | |

As shown in FIG. 6 and Table 2, as the growth reaction progressed, the average radius of the g-core sharply increased from 1.95 nm to 2.70 nm during the first 6 minutes, and then gradually reached a plateau at 2.92 nm, confirming that the thickness of the gradient layer was 0.97 nm, which is about 24.9% of the core diameter.

Meanwhile, based on the values shown in Table 2, the gradient layer was divided into a total of 7 regions, and the Te/(Te+Se) ratio in each region is shown in Table 3 below.

TABLE 3

| | | Thickness of | Gradient layer | |
|---|---|---|---|---|
| | Radius of g- | gradient layer | based on total | |
| | core (nm) | (nm) | thickness (%) | Te/(Te + Se) |
| Region 1 | 1.95-2.22 | 0-0.27 | 0-27.8 | 22.74 |
| Region 2 | 2.22-2.59 | 0.27-0.64 | 27.8-66 | 20.63 |
| Region 3 | 2.59-2.70 | 0.64-0.75 | 66-77.3 | 19.92 |
| Region 4 | 2.70-2.79 | 0.75-0.84 | 77.3-86.6 | 12.71 |
| Region 5 | 2.79-2.83 | 0.84-0.88 | 86.6-90.7 | 8.73 |
| Region 6 | 2.83-2.89 | 0.88-0.94 | 90.7-96.9 | 4.25 |
| Region 7 | 2.89-2.92 | 0.94-0.97 | 96.9-100 | 1.93 |

As shown in FIG. 3(C) and Table 3, the Te/(Te+Se) value within the gradient layer slightly decreased from 22.7% to 19.9% until the g-core radius reached 2.70 nm (thickness 0.75 nm, 77.3% of total thickness), and then sharply decreased due to the depletion of the Te precursor. As a result, the Te/(Te+Se) value was only 1.9% at the outer edge of the g-core, where Te was almost completely depleted, confirming that the Te/(Te+Se) ratio gradually decreased as it moved away from the core in the gradient layer.

FIGS. 7A to 7D show atomic mapping images using Cs-corrected scanning transmission electron microscopy (STEM) energy dispersive X-ray spectroscopy (EDS) of g-core (gradient layer coated core) prepared in Example 1.

As shown in FIGS. 7A to 7D, while Zn and Se were uniformly distributed throughout the g-core, the distribution of Te showed a distinct gradient, with Te being uniformly distributed in the core center but gradually decreasing towards the outer edge, becoming almost unobservable at the g-core's periphery (FIG. 3(D)). The decrease in Te with increasing radius is attributed to the depletion of the Te precursor and the reaction of the remaining Se-TOP in the latter half of the growth reaction.

### Experimental Example 4

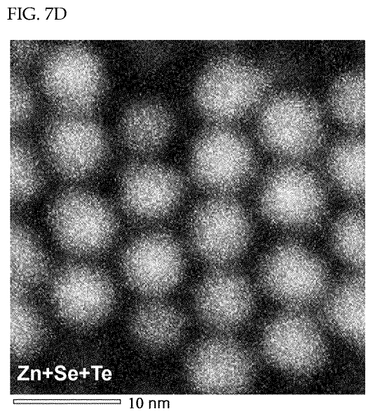

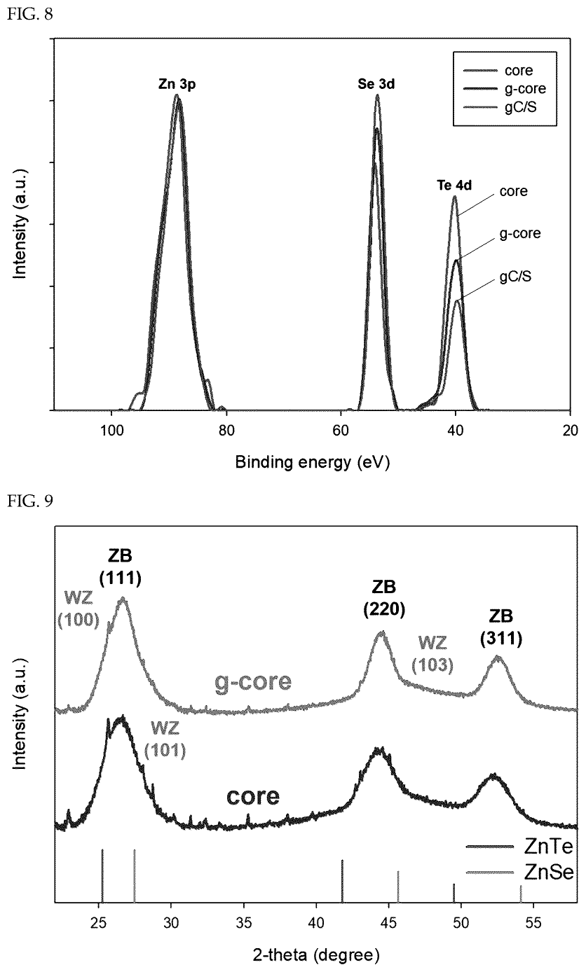

FIG. 8 shows X-ray photoelectron spectroscopy (XPS) spectra of core, g-core (gradient layer coated core), and gC/S (gradient layer coated core/shell) prepared in Example 1.

As shown in FIG. 8, the Zn 3p peaks were similarly observed in all these spectra, indicating that the formation of the gradient layer did not cause deformation of the core or the ZnSe shell. Furthermore, as the gradient layer and ZnSe shell were formed, the intensity of the Se 3d peak increased, while the intensity of the Te 4d peak decreased, suggesting that the simultaneous injection of anionic precursors effectively formed the gradient layer.

To evaluate the alleviation of lattice mismatch, X-ray diffraction (XRD) analysis was performed on the core and g-core, and the results are shown in FIG. 9.

FIG. 9 shows X-ray diffraction (XRD) patterns of core and g-core (gradient layer coated core).

As shown in FIG. 9, the lattice constant of the g-core (5.836 Å), which had almost no Te on the surface, was smaller than that of the core (5.879 Å). This decrease in lattice constant reduced the lattice mismatch at the g-core/ZnSe interface to 2.9%, a decrease compared to 3.6% at the core/ZnSe interface.

### Experimental Example 5

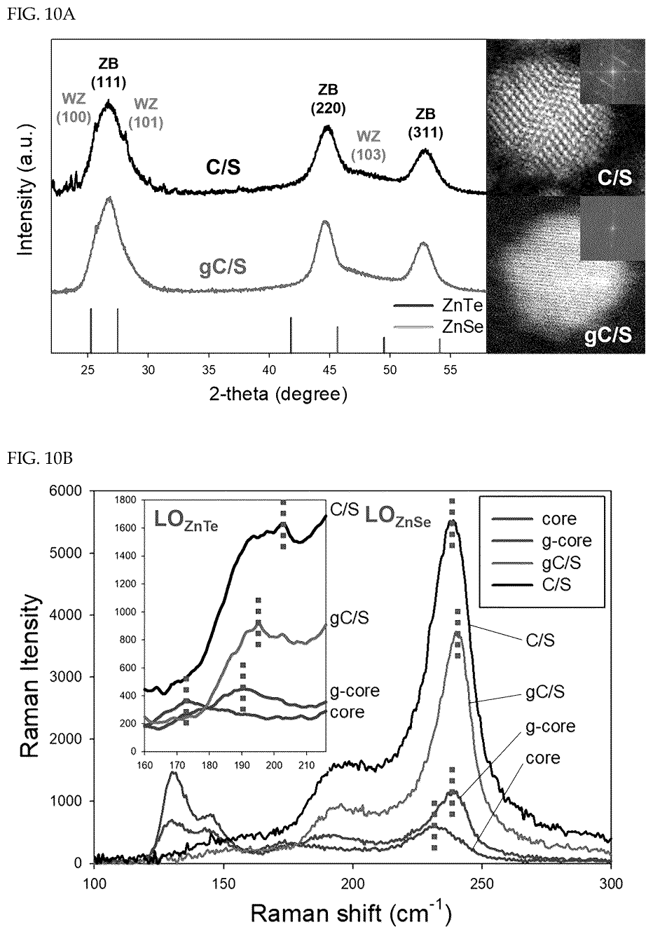

FIG. 10 shows (A) X-ray diffraction (XRD) patterns and scanning transmission electron microscopy (STEM) images (inset: FFT patterns) of C/S of Comparative Example 1 and gC/S of Example 1, and (b) Raman spectra of core, g-core, gC/S, and C/S.

As shown in FIG. 10(A), in ZnSeTe quantum dots, stacking faults occur when the cubic zinc blende (ZB) crystal structure is mixed with the hexagonal wurtzite (WZ) crystal structure, and stacking faults formed during the growth of the ZnSe shell on the ZnSeTe core were confirmed by the broadening of the C/S peak (2θ=27°) due to the WZ phase. Stacking faults resulting from the mixture of ZB and WZ phases are a cause of non-radiative processes.

In contrast, as shown in FIG. 10(A), the narrow peak of gC/S indicates that stacking faults were reduced thanks to the gradient layer. The smaller lattice constant of gC/S (5.793 Å) compared to C/S (5.820 Å) signifies the alleviation of tensile stress in the ZnSe shell. Similarly, the interplanar spacing of ZB(111) was calculated to be 0.33 nm in both gC/S and C/S through scanning transmission electron microscopy (STEM) images and fast Fourier transform (FFT) patterns.

However, the interplanar spacing of stacking faults (WZ (100)) is larger at 0.37 nm in C/S, which means that the diffraction angle of WZ(100) is smaller compared to ZB(111). In addition, the scanning transmission electron microscopy (STEM) image of C/S shows a distinct striking pattern caused by stacking faults during ZnSe shell growth, which contrasts with the normal ZB crystal structure observed in gC/S.

Furthermore, as shown in FIG. 10(A) and Table 4 below, the ratio of [peak intensity for the (100) plane due to hexagonal wurtzite (WZ) crystal structure]/[peak intensity for the (111) plane due to cubic zinc blende (ZB) crystal structure] is negligible in gC/S compared to C/S. Similarly, the ratio of [peak intensity for the (101) plane due to WZ crystal structure]/[peak intensity for the (111) plane due to ZB crystal structure] is also observed to be significantly lower. Likewise, when effective peaks for the (220) plane or (311) plane are used as a reference, the ratio of the peak for the (103) plane due to WZ crystal structure is also observed to be significantly lower.

This is attributed to the significant reduction of stacking faults in gC/S.

Such results are also confirmed by Table 4 below, where Table 4 shows the calculation results of the ratio of effective peaks due to WZ based on effective peaks due to ZB, derived from the intensity data of each peak obtained from FIG. 10(A).

TABLE 4

Intensity ratio (plane/plane)

| Sample | 100/111 | 101/111 | 103/220 | 103/311 |
|---|---|---|---|---|
| C/S | 0.758 | 0.671 | 0.262 | 0.393 |
| gC/S | 0.701 | 0.483 | 0.212 | 0.303 |

FIG. 10(B) shows the LO phonons of four particle types (core, g-core, C/S, gC/S) in the Raman spectra, where two bands were observed at 170-210 cm-1 and 220-260 cm-1, which are slightly shifted from the known LO phonon values of bulk ZnTe (206 cm-1) and ZnSe (252 cm-1). Since LO phonons are red-shifted in ternary alloys, these were assigned as ZnTe (LOZnTe) and ZnSe (LOZnSe) LO phonons of the ZnSeTe alloy.

As shown in FIG. 10(B), the LOZnTe and LOZnSe of g-core, C/S, and gC/S showed a blue shift compared to the ZnSeTe core due to changes in lattice constant caused by lattice mismatch, and the frequency shift of LOZnTe was observed to be larger in C/S compared to gC/S. This is because the gradient layer of gC/S alleviated lattice mismatch during ZnSe shell growth, resulting in a smaller change in Te lattice constant compared to C/S. The LOZnSe of gC/S is closer to the bulk LOZnSe value compared to the LOZnSe of C/S, indicating less tensile stress in the ZnSe shell.

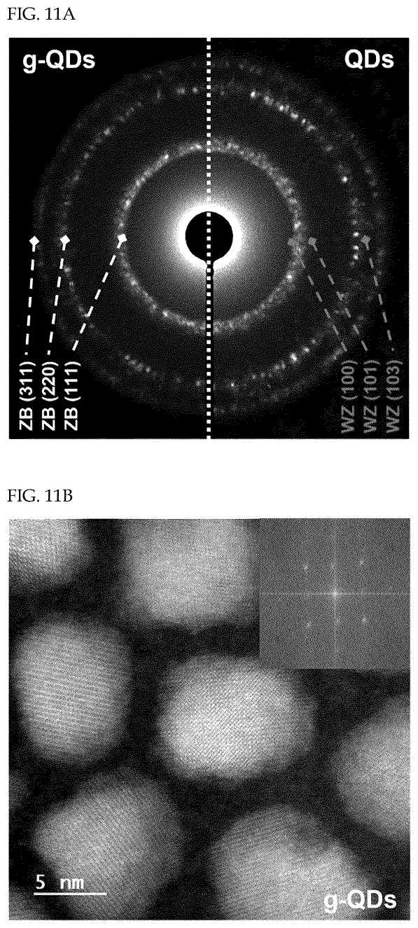

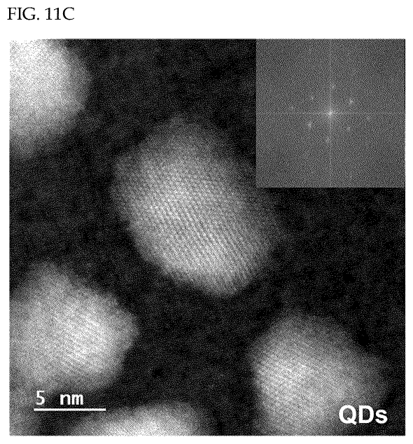

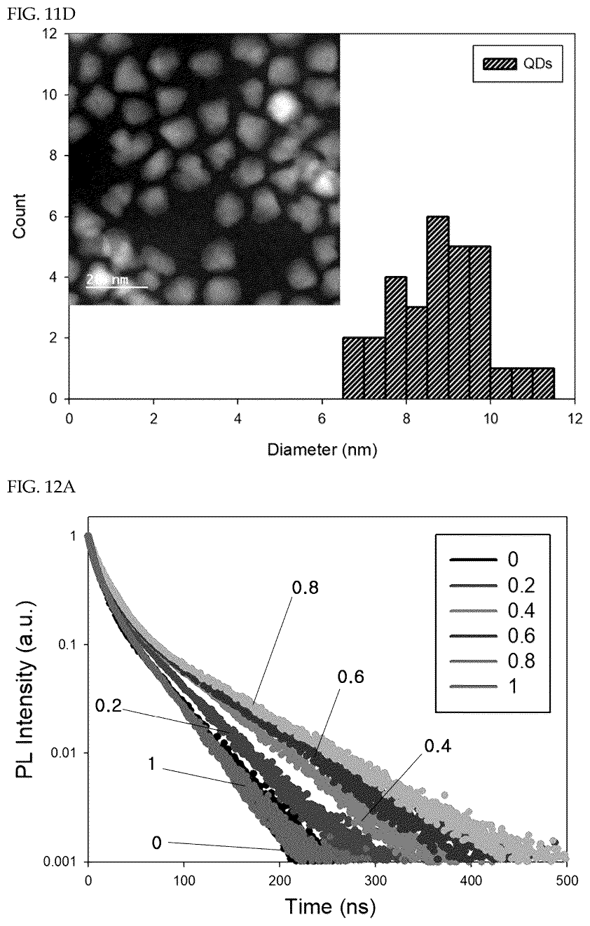

FIG. 11 shows (A) selected area electron diffraction (SAED) patterns and (B-C) scanning transmission electron microscopy (STEM) images (inset: FFT patterns) of g-core (gradient layer coated core, x=0.8) of Example 1 and QD (x=0) of Comparative Example 1, and (d) size distribution (inset: scanning transmission electron microscopy (STEM) image) of QD (x=0).

As shown in FIGS. 11A to 11D, the reduction in stacking faults in the ZnSe shell also shows the difference in crystal structure between the final quantum dots (QDs) and QDs (x=0), with QDs without a gradient layer showing blurrier patterns compared to g-QDs due to stacking faults caused by the WZ phase. The interplanar spacing of ZB was 0.31 nm in both QDs and g-QDs, but the interplanar spacing of stacking faults was larger at 0.34 nm in QDs (x=0). These stacking faults are presumed to have led to the non-uniform size distribution of the final QDs due to interfacial strain, confirming that incorporating a gradient layer into g-QDs dramatically reduces strain at the core/shell interface and eliminates stacking faults harmful to the optical properties of QDs through XRD, Raman spectroscopy, and scanning transmission electron microscopy (STEM) analysis.

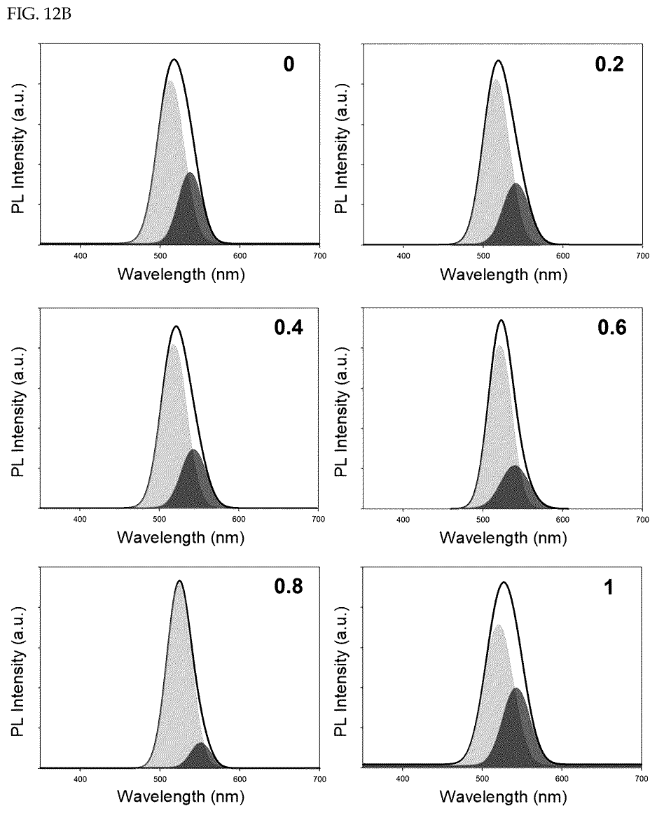

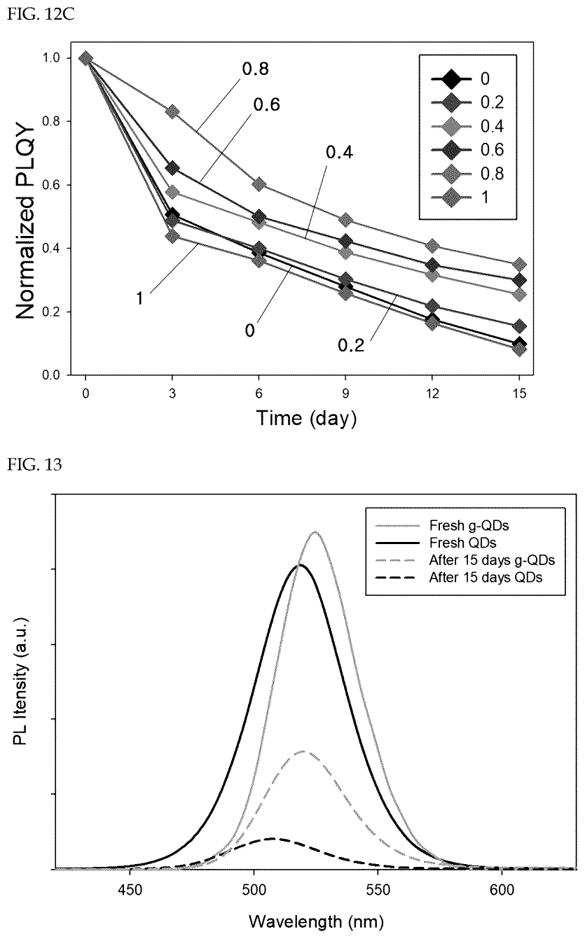

To confirm whether the reduction of interfacial defects improves the fluorescence characteristics (i.e., PLQY and FWHM) of the final quantum dots, time-resolved PL spectroscopy was used, and the results are shown in FIG. 12(A). The measured PL decay curves were well fitted by two exponential functions, and since PL lifetime is inversely proportional to the degree of overlap of electron and hole wave functions, a fast decay process implies significant overlap of electrons and holes, corresponding to band-edge luminescence. Conversely, a slow decay process with less overlap corresponds to defect luminescence.

As shown in FIGS. 11A to 11D, the interplanar spacing of ZB was observed to be 0.31 nm in both gQDs and QDs. However, the interplanar spacing of WZ stacking faults was observed to be 0.34 nm or more in QDs, whereas in gQDs, it showed results not exceeding 0.33 nm, preferably 0.325 nm, and more preferably 0.32 nm.

FIG. 12 shows (A) PL decay curves, (B) PL spectra fitted with two Gaussian linear shapes (green: band-edge luminescence, blue: defect luminescence), and (C) stability test results of final ZnSeTe quantum dots according to the x-value of ZnSeTe quantum dots prepared in Examples and Comparative Examples.

TABLE 5

| x | 0 | 0.2 | 0.4 | 0.6 | 0.8 | 1 |
|---|---|---|---|---|---|---|
| A₁ | 0.67 | 0.68 | 0.73 | 0.77 | 0.79 | 0.64 |
| τ₁ (ns) | 8.69 | 10.14 | 13.82 | 15.41 | 16.23 | 9.48 |
| A₂ | 0.33 | 0.32 | 0.27 | 0.23 | 0.21 | 0.36 |
| τ₂ (ns) | 40.42 | 49.53 | 63.36 | 73.47 | 84.7 | 39.31 |
| τ_{avg} (ns) | 30.78 | 37.59 | 44.98 | 49.52 | 56.02 | 30.36 |

As shown in Table 5, the defect luminescence rate (A2) decreased from x=0 (i.e., final QDs without a gradient layer) to a minimum of 21% as x increased. In g-QDs (x=0.8) with a gradient layer, the defect luminescence rate reached its minimum value. In addition, the average PL lifetime (Tavg) increased from 30.78 ns (x=0) to 56.02 ns (x=0.8) with the inclusion of the gradient layer, indicating a reduction in interfacial defects.

To further investigate the defect luminescence phenomenon, PL spectra at different x values were fitted with two Gaussian functions (FIG. 12(B)). The curve fitting near high energy represents the band-edge luminescence of the QDs, and the curve fitting near low energy represents the defect luminescence caused by interfacial defects between layers. As shown in FIG. 12(B), QDs without a gradient layer (x=0 or 1) showed distinct defect luminescence, whereas g-QDs (x=0.8) showed minimal defect luminescence due to reduced interfacial defects. Therefore, the results of PL decay kinetics and Gaussian fitting of PL spectra confirm that incorporating a gradient layer reduced defect luminescence in the final QDs, increased PLQY, and decreased FWHM (FIG. 2(D)).

This reduction of interfacial defects was also confirmed through a stability test of the final QDs, exposing QDs synthesized in hexane to air for 15 days at room temperature.

FIG. 13 shows fluorescence spectra (PL) before and after stability tests of quantum dots prepared in Example 1 (x=0.8, g-QDs) and Comparative Example 1 (x=0, QDs).

As shown in FIG. 12(C) and FIG. 13, g-QDs (x=0.8) with reduced interfacial defects due to the gradient layer, exhibiting less defect luminescence, showed the smallest decrease in PLQY and the smallest blue shift in PL spectra compared to other QDs, indicating improved stability.

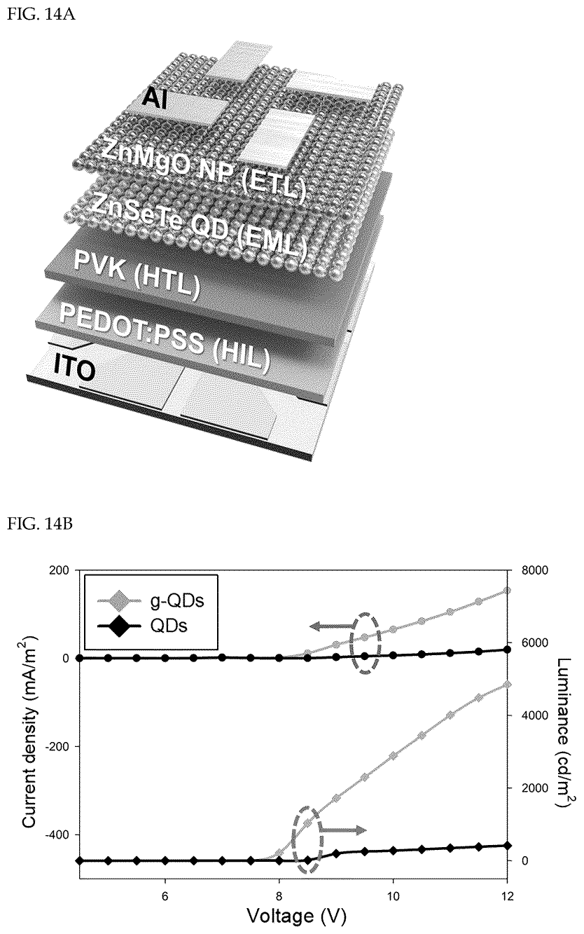

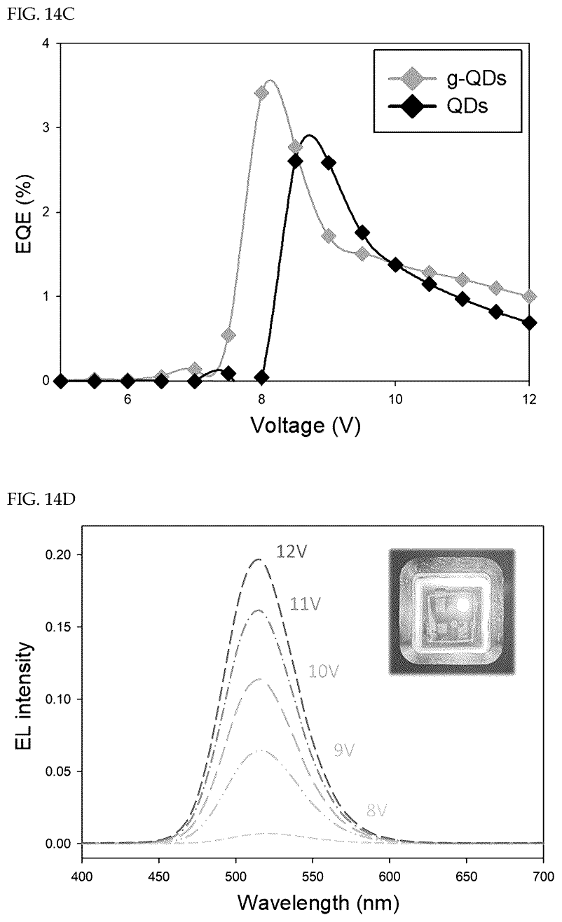

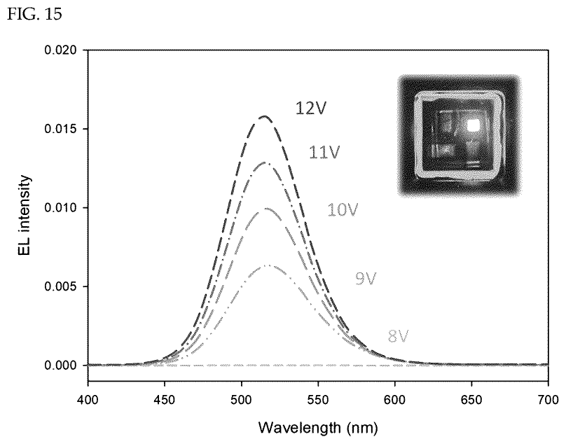

Finally, the EL characteristics of green Quantum Dot Light Emitting Diode (QLED) devices prepared in Manufacturing Example 1 were compared using ZnSeTe QDs (g-QDs with a gradient layer; x=0.8) and QDs without a gradient layer (x=0) as the emissive layer (EML), and the results are shown in FIGS. 14A to 14D and 15.

FIG. 14 shows (A) a schematic diagram of a QLED prepared in a manufacturing example, (B) voltage-dependent current density (left axis), luminance (right axis) (J-V-L) characteristics, and (C) EQE curves of devices including quantum dots of Example 1 (g-QDs, x=0.8) and Comparative Example 1 (QDs, x=0). (D) Voltage-dependent EL spectrum of a QLED using quantum dots of Example 1 (g-QDs) (inset: image of the device in operation).

FIG. 15 shows voltage-dependent EL spectra of QD without a gradient layer (x=0) of Comparative Example 1 (inset: image of the device in operation).

FIG. 14(A) shows a schematic structure of a QLED device. FIGS. 14(B) and 14(C) show the current density, luminance, and external quantum efficiency (EQE) values of QLEDs using g-QDs (x=0.8) and QDs (x=0) as functions of voltage.

As shown in FIGS. 14A to 14D and 15, devices containing g-QDs in the EML showed higher current density and higher luminance than devices containing QDs (x=0) at the same voltage. In particular, at a maximum voltage of 12V, the luminance of the device using g-QDs was 4852 cd/m², an increase of 1169% compared to 415 cd/m² for the device using QDs (x=0). In addition, the device using g-QDs had a lower turn-on voltage (4.5 V) and a higher EQE (3.42%) compared to the device using QDs (x=0), which had a turn-on voltage of 7.5 V and an EQE of 2.61%. Furthermore, through the voltage-dependent EL spectrum of the QLED using g-QDs, it can be confirmed that there is no color contamination even at high device voltages (FIG. 14(D)), and although the QLED using QDs (x=0) also had no color contamination, it can be confirmed that its EL intensity was significantly lower than that of g-QDs due to charge carrier loss caused by defects (FIG. 15). In conclusion, the gradient layer used in ZnSeTe QDs proves beneficial in achieving excellent luminescence and superior electro-optical performance.

Although the embodiments of the present invention have been described above, those skilled in the art to which the present invention pertains will be able to modify and change the present invention in various ways by adding, changing, deleting, or adding components within the scope of the spirit of the present invention described in the claims, and such modifications and changes are also included within the scope of the rights of the present invention.

What is claimed is:

1. Green quantum dots comprising: a ZnSeTe core;
a gradient layer surrounding the core, wherein the Te/(Te+Se) ratio is decreased compared to the core; and
a multi-shell surrounding the gradient layer.

2. The green quantum dots according to claim 1, wherein the diameter of the core is 2 to 7 nm.

3. The green quantum dots according to claim 1, wherein the ratio of tellurium (Te) to the sum of selenium (Se) and tellurium (Te) (Te/(Se+Te)) in the core is 10 to 45 mol %.

4. The green quantum dots according to claim 1, wherein the gradient layer includes zinc (Zn), tellurium (Te), and selenium (Se).

5. The green quantum dots according to claim 1, wherein the thickness of the gradient layer is 0.5 to 1.5 nm.

6. The green quantum dots according to claim 1, wherein the gradient layer has a Te/(Te+Se) ratio that gradually decreases from the core towards the multi-shell.

7. The green quantum dots according to claim 1, wherein the gradient layer is formed by reacting a Se-DPP solution, a Te-TOP solution, and a Se-TOP solution.

8. The green quantum dots according to claim 7, wherein, with respect to 1 mole part of the total sum of selenium (Se) in the Se-DPP solution, tellurium (Te) in the Te-TOP solution, and selenium (Se) in the Se-TOP solution, when the sum of selenium (Se) in the Se-DPP solution and tellurium (Te) in the Te-TOP solution is defined as x, the value of x is 0.2 to 0.95 mole parts.

9. The green quantum dots according to claim 1,
wherein the Te/(Te+Se) ratio of the gradient layer is 20 to 23% from the position adjacent to the core to the point that is 65% of the gradient layer thickness,
7 to 20% from the point that is 65% of the gradient layer thickness to the point that is 90% of the gradient layer thickness, and
less than 5% from the point that is 90% of the gradient layer thickness to the point that is 100% of the gradient layer thickness.

10. The green quantum dots according to claim 1, wherein the multi-shell is composed of a plurality of shells, and each of the plurality of shells has a composition in which one or more cations selected from the group consisting of zinc (Zn) and magnesium (Mg) are combined with one or more anions selected from the group consisting of sulfur (S) and selenium (Se).

11. The green quantum dots according to claim 1,
wherein the multi-shell is a triple shell consisting of a first shell surrounding the ZnSeTe core, a second shell surrounding the first shell, and a third shell surrounding the second shell, and
the composition of the first shell/second shell/third shell is ZnSe/ZnSeS/ZnS.

12. The green quantum dots according to claim 1, wherein the diameter of the quantum dot is 6 to 12 nm.

13. The green quantum dots according to claim 1, wherein the full width at half-maximum (FWHM) of the quantum dot is 30 to 43 nm, and the photoluminescence quantum yield (PLQY) is 82% or more.

14. The green quantum dots according to claim 1, wherein, as a result of X-ray diffraction (XRD) analysis of the green quantum dots,
the ratio of peak intensity for the (100) plane to peak intensity for the (111) plane is 0.73 or less, and
the ratio of peak intensity for the (101) plane to peak intensity for the (111) plane is 0.59 or less.

15. The green quantum dots according to claim 1, wherein the interplanar spacing derived from the FFT pattern analysis of the STEM image of the green quantum dots is 0.31 to 0.33 nm.

16. An optical member comprising the quantum dots of claim 1.

17. An electronic device comprising the quantum dots of claim 1.

18. A display device comprising a color conversion layer comprising the quantum dots of claim 1.
